(19) United States
(12) Patent Application Publication
(10) Pub. No.: US 2017/0187579 A1
(43) Pub. Date: Jun. 29, 2017

(54) Maximizing network fabric performance via fine-grained router link power management

(71) Applicants: Eric R. Borch, Fort Collins, CO (US); Jonathan M. Eastep, Portland, OR (US); Richard J. Greco, West Linn, OR (US)

(72) Inventors: Eric R. Borch, Fort Collins, CO (US); Jonathan M. Eastep, Portland, OR (US); Richard J. Greco, West Linn, OR (US)

(21) Appl. No.: 14/998,083

(22) Filed: Dec. 24, 2015

(51) Int. Cl. H04L 12/24; H04L 12/26; H04L 12/931; H04L 12/935; H04L 12/825

(52) U.S. Cl. CPC H04L 41/0896; H04L 49/30; H04L 47/25; H04L 49/40; H04L 43/16

(57) ABSTRACT

Systems, apparatuses and methods may provide for a smart power manager that dynamically activates or deactivates the individual lanes of each link of a router based on the allocated power limit and the connected applications. The smart power manager may optimize the router throughput for a given power limit dictated by a global power manager, and use a fine grained credit mechanism to track active lanes. The router power manager may also adjust the number of active lanes for each link individually so that highly utilized links will have more active lanes than links that are idle.

### GOVERNMENT INTEREST STATEMENT

This invention was made with Government support under contract number H98230-13-D-0124 awarded by the Department of Defense. The Government has certain rights in this invention.

### BACKGROUND

Technical Field

Embodiments generally relate to router systems. More particularly, embodiments relate to a router system that includes a smart power manager that dynamically activates and deactivates individual lanes of the links of the router.

Discussion

Enabling high bandwidth links to support applications that are network bound may involve the dedication of a significant amount of power to the network instead of to computing components and memory modules.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of a router system according to an embodiment;

FIG. 2 is a block diagram of an example of a granularity enhancement apparatus according to an embodiment;

FIG. 3 is a chart illustrating an example of a comparison between active lanes to total lanes for different power limits according to an embodiment;

FIG. 4 is a chart illustrating an example of a throughput for active lanes according to an embodiment;

FIG. 5 is a flowchart of an example of operating a granularity enhancement apparatus according to an embodiment;

FIG. 6A is a flowchart of an example of a method of altering active lanes by a link of a router according to an embodiment; and

FIG. 6B is a flowchart of an example of a method of activating and deactivating lanes of the links of a router according to an embodiment.

### DETAILED DESCRIPTION OF EXEMPLARY EMBODIMENTS

Network routers may generally be interconnected by a fabric that is tailored to high bandwidth communications. An autonomous mechanism at each router link of a network may predict future utilization of the network such that lightly utilized links may have one or more lanes powered down with little impact to overall network throughput. While this mechanism may function well, the autonomous nature of the mechanism may limit the benefits to merely reducing power consumption. A lack of integration of the autonomous mechanism with a global power manager may prevent additional benefits from being achieved. For example, if the global power manager were configured to communicate with the fabric to guide and measure network power consumption, the power savings in the network might be converted into additional performance for other parts of the system.

Techniques described herein provide for a router power manager that is able to manage the individual lanes of the links of the router in a dynamic manner by adjusting the power/bandwidth of the individual links intelligently to match the load of the router.

For example, in embodiments of the present invention, a smart power manager (or smart router manager) is provided. The smart power manager may receive an allocated power limit from a global power manager, and on the basis of the allocated power limit and connected routers or processor nodes, the smart power manager may increase the number of lane credits available to the router. The individual links may request credits to activate associated lanes. The smart power manager may optimize the router throughput for a given power limit dictated by the global power manager. By using a fine grained credit mechanism to track active lanes of the individual links, the router power manager may be able to adjust the number of active lanes for each link individually so that highly utilized links will have more active lanes (and thus more bandwidth) than links that are idle.

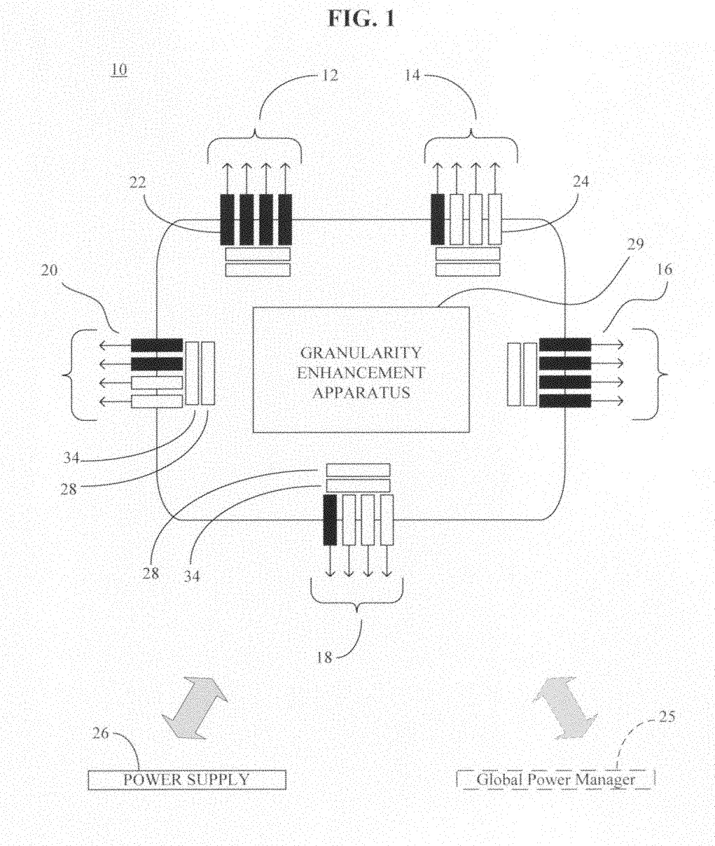

Turning now to FIG. 1, a high level view of a router 10 is illustrated. The illustrated router 10 includes a plurality of optical or electrical links (but not limited thereto), including a first link 12, a second link 14, a third link 16, a fourth link 18, and a fifth link 20. Each of the links include a plurality of lanes, each of the plurality of lanes may be in an active state 22 (indicated by the dark boxes) or an inactive state 24 (indicated by the white boxes). The links may connect the router 10 to various other external routers or processor nodes (not shown). The illustrated router 10 further includes a granularity enhancement apparatus 29. A power supply 26 may be connected to the router 10, to supply power thereto.

The router 10 may also include one or more controllers 28 and one or more link utilization managers 34. Each link of the router 10 may include a controller 28 and a link utilization manager 34. Although a separate controller 28 and a separate link utilization manager 34 are illustrated in FIG. 1, this is only exemplary, and the controller 28 and the link utilization manager 34 may be embodied as a single component.

The link utilization managers 34 may analyze the traffic flow of each lane of the links, and determine which lanes should remain active, and which lanes should be deactivated on the basis of the determined traffic flow of each link.

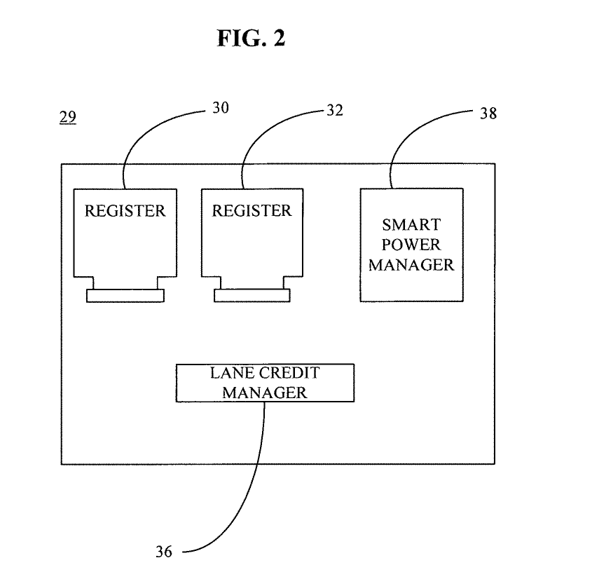

Turning now to FIG. 2, a detailed view of the granularity enhancement apparatus, such as the granularity enhancement apparatus 29 (FIG. 1), is illustrated. The granularity enhancement apparatus 29 may include a plurality of registers 30, 32, a lane credit manager 36, and a smart power manager 38.

The smart power manager 38 introduces fine-grained management of individual links on the router 10 (FIG. 1), and adapts the power and performance of each link in response to the needs of corresponding applications. The smart power manager 38 accepts a power limit from a global power manager 25 (FIG. 1), and dynamically adapts a number of active lanes for each link based on the utilization of each link. For example, in a router that has a plurality of links, and four lanes are included in each link, a link that is highly utilized may keep all four lanes active, while a link that is lightly utilized may remove two or three lanes from service. The smart power manager 38 jointly optimizes the choice of bandwidth for each link. The power allotments for each link may be tailored to the needs of the fabric and the related applications.

Assume that the power limit of the router 10 is limited to 60% of the maximum power limit. The smart power manger 38 may set the number of active lanes in each link on a link by link basis. This fine-grained process may enable the smart power manager 38 to be more precise in meeting the power budget of the router 10 (FIG. 1) when compared to the related art power manager, which may uniformly adjust the active lanes across all of the links. The smart power manager 38 may allow a greater number of lanes to be active (two more than the related art power manager) and still meet the 60% power budget. This allows the smart power manager 38 to unlock greater fabric bandwidth compared to the related art power manager at the same power budget.

If a determination is made that the first link 12 and the third link 16 have a high utilization rate, the first link 12 and the third link 16 may continue to have all four lanes active because of the determined high utilization rate, while the second link 14 and the fourth link 18, which are lightly utilized, may each have only a single active lane. This greater flexibility at the link level allows higher fabric performance for a given power level.

Returning to FIG. 2, the registers 30, 32 may perform operations such as one or more of keeping track of the current power levels dictated by the global power manager (25, FIG. 1), keeping track of how many active lanes are present in each link, keeping track of how many active lanes are present in the router 10 (FIG. 1), and keeping track of the number of used and unused credits.

A lane credit manager 36 may assign credits to (or withdraw credits from) each of the links in order to activate lanes of the links on the basis of a received power limit. The lane credit manager 36 is thus able to determine how many active lanes are present in each link on the basis on the number of assigned credits. A credit is associated with each lane associated with the plurality of links. In other words, the number of credits may be equal to the number of lanes included in each link of the router 10. Each active lane of a link requires a credit from the lane credit manager 36. The total number of lane credits on router 10 (FIG. 1) may be set by the smart power manager 38 according to the available power received from the global power manager 25 (FIG. 1).

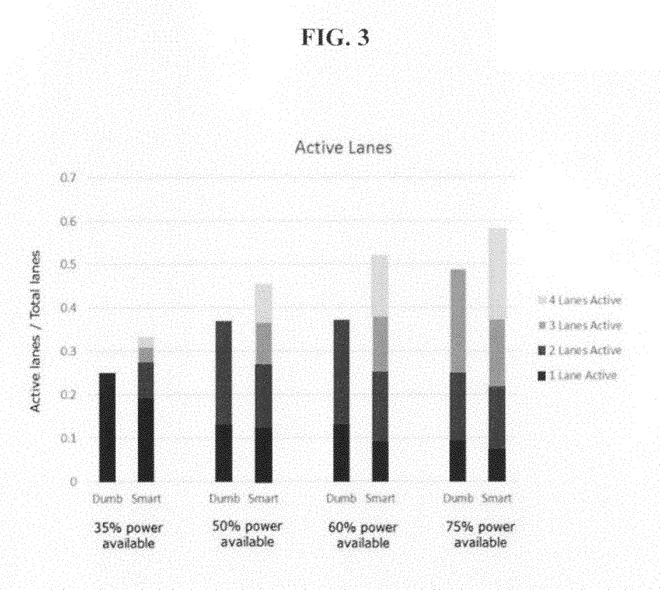

Turning now to FIG. 3, a comparison of the ratio of active lanes of the plurality of links to total lanes for four different power limits using a three dimensional (3D) nearest neighbor type traffic pattern is illustrated. Specifically, the chart illustrates a simulation of the fabric, and compares the performance of a related art power manager and the smart power manager 38 (FIG. 2). The 35% available power, 50% available power, 60% available power, and 75% available power as illustrated in FIG. 3 indicate the amount of power that the global power manager 25 tells the router 10 they are permitted to use. These power limits are exemplary, and any power limit may be adapted based on the needs of the fabric.

As illustrated in FIG. 3, at a 35% power limit, each of the related art routers have to uniformly reduce power to all of the links of the router. Accordingly, each link in the router system will only have 25% of the total lanes active.

On the other hand, in an exemplary embodiment the router 10 may finely adjust the individual lanes of each link to more closely attain the 35% power limit. Therefore, 35% of the lanes may be active across the router 10. Since the smart power manager 38 may be able to activate any number of lanes per link, it is able to maintain more total active lanes than the related art router power manager.

Within each column illustrated in FIG. 3, there is a breakdown for each link to represent how many lanes are active. At the 35% power limit case, the related art power manager may only have one active lane per link, while the smart power manager 38 (FIG. 2) may have any number of lanes active per link as long as the total number of active lanes does not exceed the total number of active lanes allowed. In this case, there are a number of links that are more heavily utilized and thus may have more active lanes. Similar trends hold for the 50%, 60%, and 75% power limit. The smart power manager 38 (FIG. 2) is able to allow lanes with high utilization to have more lanes active than the related art power manager would allow.

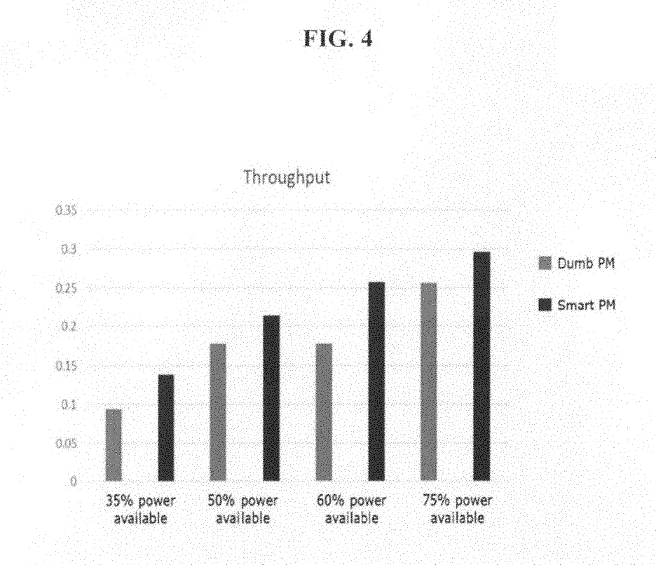

Turning now to FIG. 4, a view of the overall throughput of the fabric or network is illustrated. Since more lanes may be activated using the smart power manager 38 (FIG. 2) the throughput across the network increases for each power limit. The flexibility of the smart power manager 38 (FIG. 2) to allocate lanes where they are needed gives a direct benefit to the overall throughput of the network.

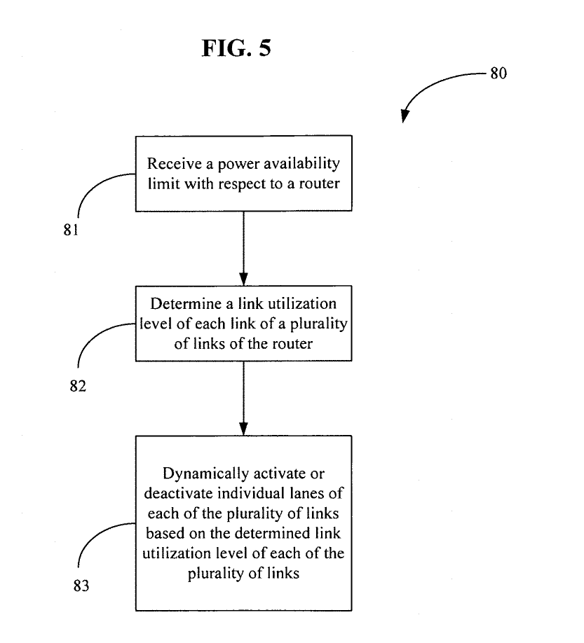

FIG. 5 shows a method 80 for activating or deactivating lanes of the links of the router 10. The method 80 may be implemented as a module or related component in a set of logic instructions stored in a non-transitory machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

In block 81, a power availability limit with regard to the router is received from the global power manager 25 (FIG. 1). In block 82, a link utilization level of each link of a plurality of links of the router is determined. In block 83, individual lanes of each of the plurality of links are dynamically activated or deactivated based on the determined link utilization level of each of the plurality of links.

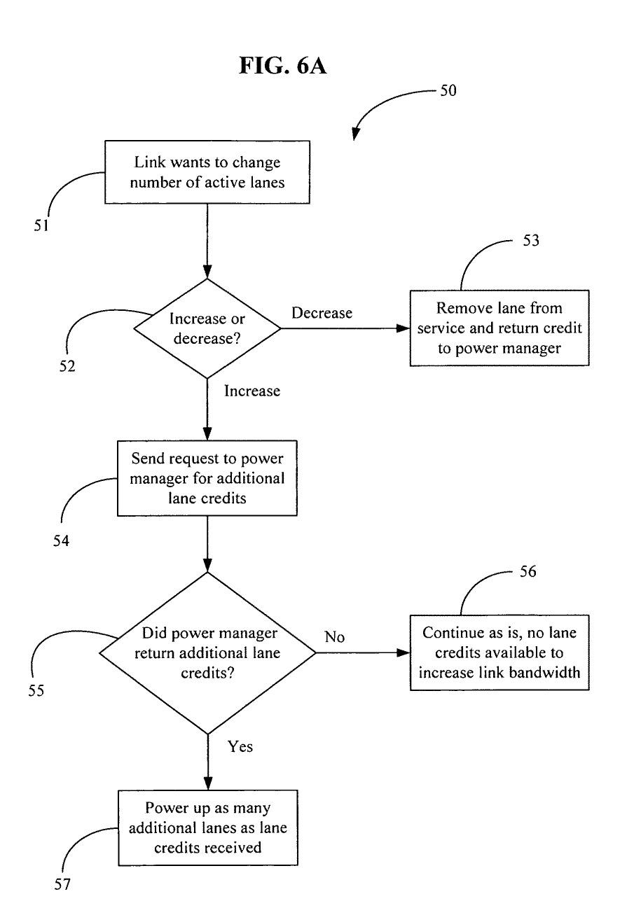

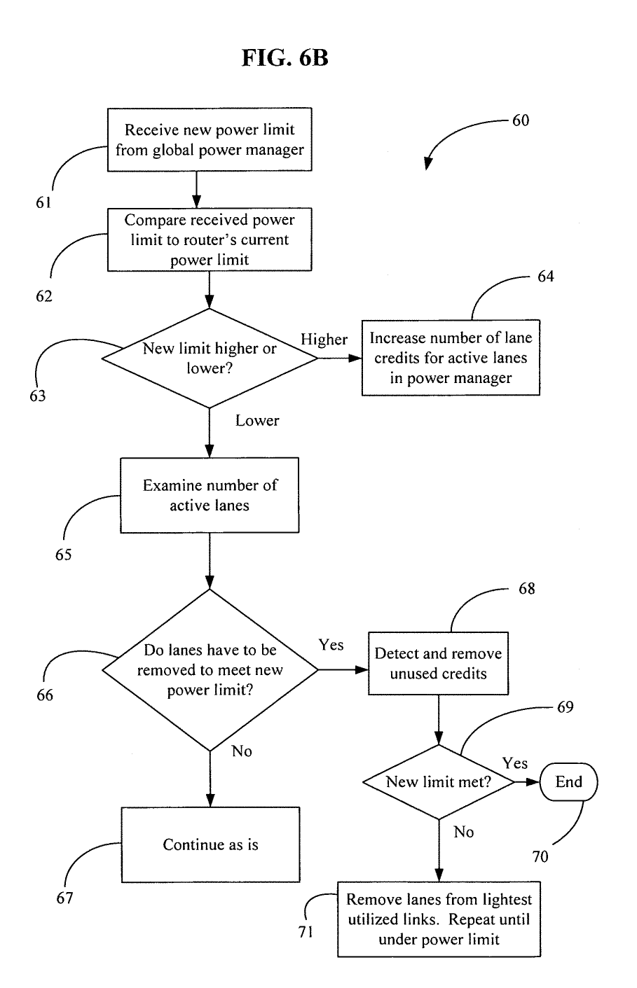

Turning now to FIG. 6A a method 50 of altering active lanes from the perspective of an individual link is illustrated. The method 50 may be implemented as a module or related component in a set of logic instructions stored in a non-transitory machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

If it is determined at block 51 that a link has requested a change in a number of active lanes 51, a determination is made at illustrated block 52 whether the link wishes to increase or decrease the number of active lanes. If the decision is to decrease the number of active lanes in the link, one or more lanes are removed from service at block 53, and the lane credit associated with the removed lane is returned to the lane credit manager at block 36, and the operation ends.

If instead, the decision at block 52 is to increase the number of active lanes in the link, or when a link wants to activate one or more lanes, a request is sent at block 54 to the lane credit manager 36, requesting a number of additional lane credits equal to the number of lanes that are to be activated. For example, if a single lane has to be activated, the link sends a request for one lane credit to the lane credit manager 36. If two lanes have to be activated, the link sends a request for two lane credits to the lane credit manager 36. If credits are available, the lane credit manager 36 returns at block 55 the requested credits, (or fewer credits than the requested credits), to the requesting link, and the lanes may be activated at block 57. At block 56, if no credits are available, none are returned and the lanes cannot be activated.

FIG. 6B illustrates a method 60 of activating or deactivating lanes wherein a smart power manager may receive a power limit from the global power manager, set the correct number of lane credits, and manage the lane credits across the router 10. The method 60 may be implemented as a module or related component in a set of logic instructions stored in a non-transitory machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

When the global power manager 25 (FIG. 1) increases the power available for the router 10 (FIG. 1) to use, the smart power manager 38 (FIG. 2) simply increases the number of lane credits available for use by the router 10 (FIG. 1). These new credits are available immediately for any link that requests to activate additional lanes. The smart power manager 38 (FIG. 2) does not proactively activate lanes across the router 10 (FIG. 1).

Returning to FIG. 6B, at block 61, the router receives a new power limit from the global power manger. The new power limit is compared at block 62 with the current power limit of the router. If it is determined at block 63 that the new power limit is higher than the current power limit of the router, the number of lane credits for active lanes are increased at block 64 in the smart power manager.

On the other hand, if it is determined at block 63 that the new power limit is lower than the current power limit of the router, the number of active lanes in the links are examined at block 65. A determination is made at block 66 whether lanes have to be removed from individual links to meet the new power limit. If lanes do not have to be removed, the operation of the router continues at block 67.

If the new power limit is lower than the current power limit of the router (10, FIG. 1), and a determination is made at block 66 that lanes have to be removed, at block 68, the lane credit manager (36, FIG. 2) ascertains whether there are any unused credits in the links. If there are unused credits in the links, the unused credits are removed. If it is determined at block 69 that the removal of the unused credits is sufficient to meet the new power limit, at block 70 the process ends. If, however, it is determined at block 69 that the removed unused credits are not enough to meet the new lower power limit, and more credits have to be removed from the links, the smart power manager 38 (FIG. 2) will have to reclaim credits from active router links at block 71. The smart power manager starts by notifying links with two active lanes that it needs to deactivate a lane and the link needs to return the credit to the lane credit manager. If this is not enough, the process is repeated, but for links with three active lanes. Finally the process will proceed to the links that have four active lanes if there is still a need to reclaim credits. The intent is to allow the highly utilized links to keep as many lanes active as possible to maintain overall throughput.

### Additional Notes and Examples

Example 1 may include a router system comprising a power source to supply power to the router, a plurality of links to communicate with one or more of processor nodes or external routers, wherein each of the plurality of links includes a plurality of lanes, a power manager, connected to the plurality of links, to receive a power availability limit with respect to the router, one or more link utilization managers to determine a link utilization level of each link of the plurality of links of the router, and one or more controllers to dynamically activate or deactivate individual lanes of each of the plurality of links based on the determined link utilization level of each of the plurality of links.

Example 2 may include the router of example 1, wherein all lanes of a link of the plurality of links are to remain active when the link utilization level of the link is greater than a predetermined threshold, and individual lanes of the link are to be deactivated when the link utilization level of the link is below the predetermined threshold.

Example 3 may include the router of example 1, wherein the one or more link utilization managers are to track active lanes in each of the plurality of links to determine the link utilization level.

Example 4 may include the router of any one of examples 1 to 3, further comprising a lane credit manager to assign lane credits to each active lane.

Example 5 may include the router of example 4, wherein the lane credit manager is to transmit, in response to one or more credit requests, one or more credit notifications to one or more of the plurality of links based on the assigned lane credits, wherein the one or more credit notifications are associated with one or more individual lane activations, and receive one or more credit returns from one or more of the plurality of links, wherein the credit returns are associated with one or more individual lane deactivations.

Example 6 may include the router of example 4, wherein the lane credit manager is to determine the lane credits based on the received power availability limit.

Example 7 may include a granularity enhancement apparatus comprising a power manager to receive a power availability limit with respect to a router, one or more link utilization managers to determine a link utilization level of each link of a plurality of links of the router, and one or more controllers to dynamically activate or deactivate individual lanes of each of the plurality of links based on the determined link utilization level of each of the plurality of links.

Example 8 may include the apparatus of example 7, wherein all lanes of a link of the plurality of links are to remain active when the link utilization level of the link is greater than a predetermined threshold, and individual lanes of the link are to be deactivated when the link utilization level of the link is below the predetermined threshold.

Example 9 may include the apparatus of example 7, wherein the one or more link utilization managers are to track active lanes in each of the plurality of links to determine the link utilization level.

Example 10 may include the apparatus of any one of examples 7 to 9, further comprising a lane credit manager to assign lane credits to each active lane.

Example 11 may include the apparatus of example 9, wherein the lane credit manager is to transmit, in response to one or more credit requests, one or more credit notifications to one or more of the plurality of links based on the assigned lane credits, wherein the one or more credit notifications are associated with one or more individual lane activations and receive one or more credit returns from one or more of the plurality of links, wherein the credit returns are associated with one or more individual lane deactivations.

Example 12 may include the apparatus of example 9, wherein the lane credit manager is to determine the lane credits based on the received power availability limit.

Example 13 may include a method of operating a granularity enhancement apparatus, comprising receiving a power availability limit with respect to a router, determining a link utilization level of each link of a plurality of links of the router, and dynamically activating or deactivating individual lanes of each of the plurality of links based on the determined link utilization level of each of the plurality of links.

Example 14 may include the method of example 13, wherein all lanes of a link of the plurality of links remain active when the link utilization level of the link is greater than a predetermined threshold and individual lanes of the link are deactivated when the link utilization level of the link is below the predetermined threshold.

Example 15 may include the method of example 13, wherein determining the link utilization level includes tracking active lanes in each of the plurality of links.

Example 16 may include the method of any one of examples 13 to 15, further comprising assigning lane credits to each active lane.

Example 17 may include the method of example 15, further including transmitting, in response to one or more credit requests, one or more credit notifications to one or more of the plurality of links based on the assigned lane credits, wherein the one or more credit notifications are associated with one or more individual lane activations, and receiving one or more credit returns from one or more of the plurality of links, wherein the credit returns are associated with one or more individual lane deactivations.

Example 18 may include the method of example 15, further including determining the lane credits based on the received power availability limit.

Example 19 may include at least one computer readable storage medium comprising a set of instructions, which when executed by an apparatus, cause the apparatus to receive a power availability limit with respect to a router, determine a link utilization level of each link of a plurality of links of the router, and dynamically activate or deactivate individual lanes of each of the plurality of links based on the determined link utilization level of each of the plurality of links.

Example 20 may include the at least one computer readable storage medium of example 19, wherein all lanes of a link of the plurality of links remain active when the link utilization level of the link is greater than a predetermined threshold and individual lanes of the link are deactivated when the link utilization level of the link is below the predetermined threshold.

Example 21 may include the at least one computer readable storage medium of example 19, wherein the instructions, when executed, cause the apparatus to track active lanes in each of the plurality of links to determine the link utilization level.

Example 22 may include the at least one computer readable storage medium of any one of examples 19 to 21, wherein the instructions, when executed, cause the apparatus to assign lane credits to each active lane.

Example 23 may include the at least one computer readable storage medium of example 22, wherein the instructions, when executed, cause the apparatus to transmit, in response to one or more credit requests, one or more credit notifications to one or more of the plurality of links based on the assigned lane credits, wherein the one or more credit notifications are associated with one or more individual lane activations, and receive one or more credit returns from one or more of the plurality of links, wherein the credit returns are associated with one or more individual lane deactivations.

Example 24 may include the at least one computer readable storage medium of example 22, wherein the lane credits available for use by the router are based on the received power availability limit.

Example 25 may include a granularity enhancement apparatus comprising means for receiving a power availability limit with respect to a router, means for determining a link utilization level of each link of a plurality of links of the router, and means for dynamically activating or deactivating individual lanes of each of the plurality of links based on the determined link utilization level of each of the plurality of links.

Example 26 may include the apparatus of example 25, wherein all lanes of a link of the plurality of links are to remain active when the link utilization level of the link is greater than a predetermined threshold, and individual lanes of the link are to be deactivated when the link utilization level of the link is below the predetermined threshold.

Example 27 may include the apparatus of example 25, wherein the link utilization level is to be determined by tracking active lanes in each of the plurality of links.

Example 28 may include the apparatus of example 27, further comprising means for assigning lane credits to each active lane.

Example 29 may include the apparatus of any one of examples 27 to 28, further including means for transmitting, in response to one or more credit requests, one or more credit notifications to one or more of the plurality of links based on the assigned lane credits, wherein the one or more credit notifications are associated with one or more individual lane activations, and means for receiving one or more credit returns from one or more of the plurality of links, wherein the credit returns are associated with one or more individual lane deactivations.

Example 30 may include the apparatus of any one of examples 27-28, wherein the lane credits available for use by the router are based on the received power availability limit.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments of this have been described in connection with particular examples thereof, the true scope of the embodiments should not be so limited since other modifications will become apparent to the skilled practitioner upon a study of the drawings, specification, and following claims.

We claim:

1. A router comprising:
an interface to communicate with a power supply source;
a plurality of links to communicate with one or more of processor nodes or external routers, wherein each of the plurality of links includes a plurality of lanes;
a power manager, connected to the plurality of links, to receive a power availability limit with respect to the router;
one or more link utilization managers to determine a link utilization level of each link of the plurality of links of the router; and
one or more controllers to dynamically activate or deactivate individual lanes of each of the plurality of links based on the determined link utilization level of each of the plurality of links.

2. The router of claim 1, wherein all lanes of a link of the plurality of links are to remain active when the link utilization level of the link is greater than a predetermined threshold, and individual lanes of the link are to be deactivated when the link utilization level of the link is below the predetermined threshold.

3. The router of claim 1, wherein the one or more link utilization managers are to track active lanes in each of the plurality of links to determine the link utilization level.

4. The router of claim 3, further comprising a lane credit manager to assign lane credits to each active lane.

5. The router of claim 4, wherein the lane credit manager is to transmit, in response to one or more credit requests, one or more credit notifications to one or more of the plurality of links based on the assigned lane credits; wherein the one or more credit notifications are associated with one or more individual lane activations, and receive one or more credit returns from one or more of the plurality of links, wherein the credit returns are associated with one or more individual lane deactivations

6. The router of claim 4, wherein the lane credit manager is to determine the lane credits based on the received power availability limit.

7. An apparatus comprising:
a power manager to receive a power availability limit with respect to a router;
one or more link utilization managers to determine a link utilization level of each link of a plurality of links of the router; and
one or more controllers to dynamically activate or deactivate individual lanes of each of the plurality of links based on the determined link utilization level of each of the plurality of links.

8. The apparatus of claim 7, wherein all lanes of a link of the plurality of links are to remain active when the link utilization level of the link is greater than a predetermined threshold, and individual lanes of the link are to be deactivated when the link utilization level of the link is below the predetermined threshold.

9. The apparatus of claim 7, wherein the one or more link utilization managers are to track active lanes in each of the plurality of links to determine the link utilization level.

10. The apparatus of claim 9, further comprising a lane credit manager to assign lane credits to each active lane.

11. The apparatus of claim 10, wherein the lane credit manager is to transmit, in response to one or more credit requests, one or more credit notifications to one or more of the plurality of links based on the assigned lane credits, wherein the one or more credit notifications are associated with one or more individual lane activations and receive one or more credit returns from one or more of the plurality of links, wherein the credit returns are associated with one or more individual lane deactivations.

12. The apparatus of claim 10, wherein the lane credit manager is to determine the lane credits based on the received power availability limit.

13. A method comprising:
receiving a power availability limit with respect to a router;
determining a link utilization level of each link of a plurality of links of the router; and
dynamically activating or deactivating individual lanes of each of the plurality of links based on the determined link utilization level of each of the plurality of links.

14. The method of claim 13, wherein all lanes of a link of the plurality of links remain active when the link utilization level of the link is greater than a predetermined threshold and individual lanes of the link are deactivated when the link utilization level of the link is below the predetermined threshold.

15. The method of claim 13, wherein determining the link utilization level includes tracking active lanes in each of the plurality of links.

16. The method of claim 15, further comprising assigning lane credits to each active lane.

17. The method of claim 16, further including:
transmitting, in response to one or more credit requests, one or more credit notifications to one or more of the plurality of links based on the assigned lane credits, wherein the one or more credit notifications are associated with one or more individual lane activations; and
receiving one or more credit returns from one or more of the plurality of links, wherein the credit returns are associated with one or more individual lane deactivations.

18. The method of claim 16, further including determining the lane credits based on the received power availability limit.

19. At least one computer readable storage medium comprising a set of instructions, which when executed by an apparatus, cause the apparatus to:
receive a power availability limit with respect to a router;
determine a link utilization level of each link of a plurality of links of the router; and
dynamically activate or deactivate individual lanes of each of the plurality of links based on the determined link utilization level of each of the plurality of links.

20. The at least one computer readable storage medium of claim 19, wherein all lanes of a link of the plurality of links remain active when the link utilization level of the link is greater than a predetermined threshold and individual lanes of the link are deactivated when the link utilization level of the link is below the predetermined threshold.

21. The at least one computer readable storage medium of claim 19, wherein the instructions, when executed, cause the apparatus to track active lanes in each of the plurality of links to determine the link utilization level.

22. The at least one computer readable storage medium of claim 21, wherein the instructions, when executed, cause the apparatus to assign lane credits to each active lane.

23. The at least one computer readable storage medium of claim 22, wherein the instructions, when executed, cause the apparatus to:
transmit, in response to one or more credit requests, one or more credit notifications to one or more of the plurality of links based on the assigned lane credits, wherein the one or more credit notifications are associated with one or more individual lane activations; and
receive one or more credit returns from one or more of the plurality of links, wherein the credit returns are associated with one or more individual lane deactivations.

24. The at least one computer readable storage medium of claim 22, wherein the instructions, when executed, cause the apparatus to determine the lane credits based on the received power availability limit.
